(19) United States
(12) Patent Application Publication
(10) Pub. No.: US 2008/0014064 A1
(43) Pub. Date: Jan. 17, 2008

(54) BOTTLED WATER DISPENSER

(76) Inventor: Charles Dixon, Oceanside, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/777,964

(22) Filed: Jul. 13, 2007

Related U.S. Application Data
(60) Provisional application No. 60/831,058, filed on Jul. 14, 2006.

(51) Int. Cl. B65G 65/34

(52) U.S. Cl. 414/419

(57) ABSTRACT

Embodiments of an improved bottled water dispenser are loadable from beneath, and may include a movable cart which is used to position the water bottle in the bottled water dispenser. The movable cart may be angled to facilitate removal of water from the bottle, and may include a retaining feature and a drawbridge to facilitate loading of the bottle onto the platform. In other embodiments, the water dispenser includes a funnel member positioned at the top of the bottle, and a rod member which is movable to engage the funnel member, placing a pump in fluid communication with the water.

### BACKGROUND OF THE INVENTION

1. Field of the Invention

Embodiments of the present invention generally relate to improved fluid dispensers.

2. Description of the Related Art

Current bottled water dispensers comprise certain undesirable features. Most notably, the vast majority of bottled water dispensers require that a full bottle of water be lifted well off the ground, inverted, and placed on the bottled water dispenser. Such designs limit the number of potential users of bottled water dispensers, as many potential customers are unable or unwilling to lift and maneuver heavy bottles full of water. Even among users who are physically capable of using such dispensers, there is a significant risk of injury during this loading process.

Certain current bottled water dispenser designs attempt to solve this problem by permitting the bottle to be loaded near or adjacent to the base of the bottled water dispenser, and permit the bottle to be oriented with the top facing upward, such that the bottle need not be inverted during the loading process. However, while these designs partially alleviate the difficulty and risks associated with loading the full bottles of water, they still require that the water bottle be manually moved into position in or near the dispenser. Thus, even these inverted bottle dispensers require a significant amount of strength and coordination to load the full bottles.

### SUMMARY OF THE INVENTION

In one embodiment, an apparatus for dispensing fluid from a container is provided, the apparatus including a movable platform configured to support a container, the movable platform including a first surface, where the first surface is configured to support the container such that the upper surface of fluid within the container is at an angle to the first surface, a ramp member connected to an edge of the first surface via a hinge, the ramp member being rotatable about the hinge from a first position in which an edge of the ramp member is in contact with the ground, to a second position in which an edge of the ramp member is supported by either the first platform or a container located on the platform, and a substantially vertical member extending upward from the platform, a flexible member configured to extend around at least a portion of the container, and a gear box supported by the substantially vertical member and operably connected to the flexible member, where the gear box is configured to pull the flexible member towards the gear box.

In another embodiment, an apparatus for dispensing fluid from a container is provided, the apparatus including a platform configured to support a container, such that an upper surface of fluid within the container is at an angle to the platform, a rod member, including a first lumen extending the length of the rod member, the lumen including a first end located at the distal end of the rod member, and the second end located at the proximal end of the rod member, and a second lumen including a first end located at an aperture in the side of the rod member near the distal end of the rode member, and a second end in fluid communication with a portion of the first lumen, a funnel member configured to be placed in an aperture located in an upper surface of a container, where the funnel member is configured to receive the distal end of the rod member, the funnel member including a hollow conical portion having an outer diameter at the widest point of the conical portion which is larger than the diameter of the aperture, a substantially cylindrical portion extending from the narrower end of the conical portion, the substantially cylindrical portion including a luminal area configured to receive the rod member, and a flexible tube in fluid communication with the luminal area of the substantially cylindrical portion, where the flexible tube is configured to reach substantially the lowest portion of the container.

In another embodiment, a method of preparing an apparatus to dispense fluid from a container is provided, the method including inserting a funnel member into an aperture in an upper surface of the container, the funnel member including a hollow conical portion, a substantially cylindrical portion extending from the narrow end of the conical portion, and a flexible tube extending from the substantially cylindrical portion toward the base of the container, securing a flexible member around at least a portion of the container, actuating a gear box to pull the flexible member toward the gear box, thereby pulling the container onto a movable platform to which the gear box and the flexible member are operably connected, the movable platform including a ramp member extending downward at an angle from the edge of a first surface, the first surface configured to support the container such that an upper surface of fluid within the container is oriented at an angle to the first surface, and translating a rod member along the axis of the rod member to engage the distal end of the rod member with the funnel member, such that the proximal end of the rod member is in fluid communication with the distal end of the flexible tube.

In another embodiment, a method of preparing an apparatus to dispense fluid from a container is provided, the method including inserting a funnel member into an aperture in an upper surface of the container, the funnel member including a hollow conical portion, a substantially cylindrical portion extending from the narrow end of the conical portion and including a lumen extending though the cylindrical portion, and a flexible tube extending from the substantially cylindrical portion toward the base of the container and in fluid communication with the lumen, and translating a rod member along the axis of the rod member to engage the distal end of the rod member with the lumen extending through the cylindrical portion, such that the proximal end of the rod member is in fluid communication with the distal end of the flexible tube.

In another embodiment, a method of positioning a container in preparation for dispensing fluid from the container is provided, the method including positioning a movable platform adjacent the container, the movable platform including a ramp member extending from the edge of a first surface, and rotatable with respect to the edge, positioning the ramp member such that the ramp member extends downward at an angle from the edge of the first surface, securing a flexible member around at least a portion of the container, actuating a gear box to pull the flexible member toward the gear box, thereby pulling the container onto the first surface of the movable platform, where the first surface supports the container such that an upper surface of fluid within the container is oriented at an angle to the first surface, and moving the movable platform to a position whereby fluid can be dispensed.

In another embodiment, an apparatus for dispensing fluid from a container is provided, the apparatus including means for positioning the container, where the positioning means are configured to support the container such that an upper surface of the fluid is oriented at an angle to the base of the container, means for securing the container to the positioning means, means for loading the container onto the positioning means, where the loading means are configured to translate the securing means with respect to the positioning means, thereby pulling the container onto the positioning means, and means for dispensing fluid from the container, where the dispensing means simultaneously permit the influx of air into the container as fluid is dispensed.

### BRIEF DESCRIPTION OF THE DRAWINGS

FIG. 1 is a schematic cross-section of the interior of one embodiment of a fluid dispenser.

FIG. 2 is a schematic side view of an embodiment of a movable cart for loading and positioning fluid containers.

FIG. 3 is a schematic cross-section of embodiments of a funnel member and a rod member configured to engage the funnel member, for use in removing fluid from a container.

FIG. 4A is a side view of an embodiment of a fluid dispenser.

FIG. 4B is a rear view of the fluid dispenser of FIG. 4A.

### DETAILED DESCRIPTION OF THE PREFERRED EMBODIMENT

Embodiments of the present invention provide dispensers for bottled water or other fluids which address certain of the problems associated with existing bottled water dispensers. In particular, certain embodiments of the present invention provide a fluid dispensing system which does not require that the user have the strength or dexterity to lift a full bottle of water or to invert the bottle of water during the loading process.

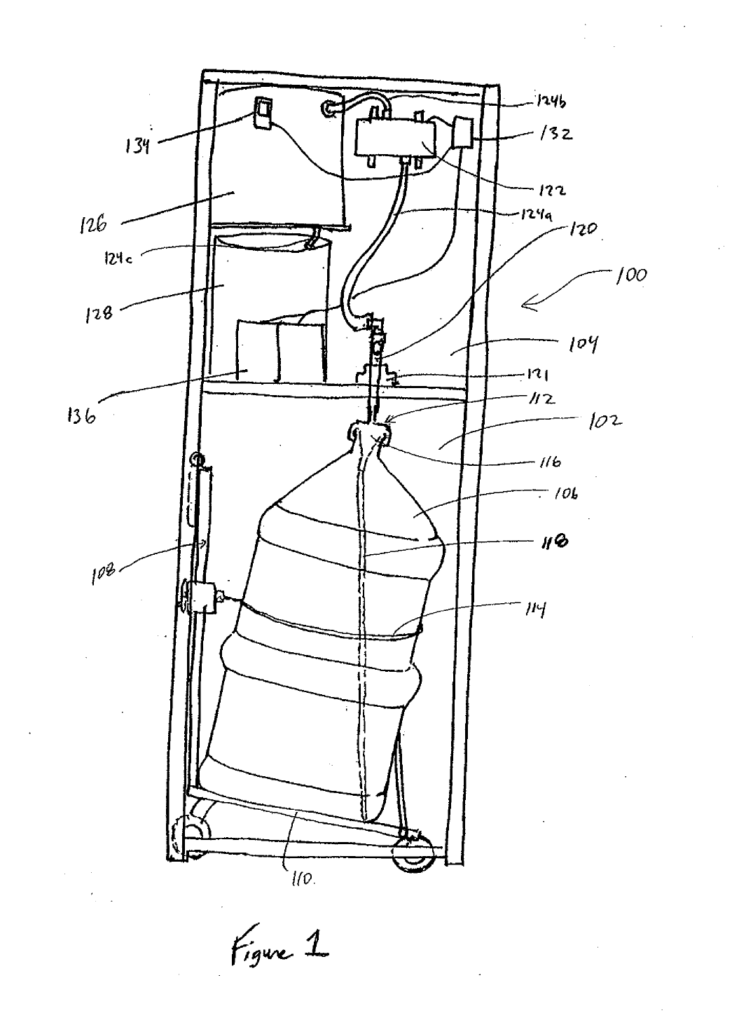

A first embodiment is described with respect to FIG. 1, which schematically illustrates a cross-sectional view of a fluid dispenser 100. In the illustrated embodiment, the fluid dispenser 100 comprises a first chamber 102 located at the base of the dispenser 100, which is at least large enough to hold a bottle 106 or other appropriate fluid container. A second chamber 104 is located above the first chamber 102, and is configured to retain a variety of components which will be discussed in greater detail below. While the chambers 102 and 104 may be located in other positions relative to one another, the placement of the chamber 102 at the base of the dispenser advantageously permits the bottle 106 to be positioned within the chamber 102 without significant lifting of the bottle. In alternate embodiments, the second chamber 106 may be located to one side of the first chamber. Further, it will be understood that chambers 102 and 104 need not be isolated from one another, but that a single chamber may contain both the bottle 106 and other components, which may be anchored to the interior walls of the chamber or supported by shelves extending across a portion of the chamber.

It can be seen in the illustrated embodiment that the bottle 106 is supported within the first chamber 102 by a movable cart 108, which comprises a platform 110 on which the bottle 106 rests. Advantageously, as seen in the illustrated embodiment, the platform 110 is oriented at an angle to the ground such that when only a small amount of water remains in the bottle 106, the water that remains collects in a portion of the bottle located substantially underneath the opening 112 in the top of the bottle 106. The cart 108 also contains a retention feature 114 extending around the bottle 106 configured to retain the bottle 106 in place.

Near the top of the bottle 106, it can be seen that a funnel member 116 has been positioned in the opening 112, and a tube member 118 extends from the lower portion of the funnel member 116 into the interior of the bottle 106. Although described herein as a funnel member, it will be understood that while the member may advantageously comprise a funnel-like tapering shape, a wide variety of shapes may be suitable and may be used in other embodiments. In order to minimize the amount of fluid left in the bottle, the tube member 118 advantageously extends to the base of the bottle 106. Preferably, it can extend to the most distant part of the base of the bottle. The tube member may comprise any suitable material or shape, and may even comprise, e.g., a pipe, although the tube member 118 is advantageously flexible or pliable and is configured to permit fluid flow between the bottle 106 and funnel member 116. A rod member 120 is actuatable along the axis of the rod member 120 between a first position where the rod member 120 engages the funnel member 116 and a second position where the rod member 120 no longer engages the funnel member 116, and wherein movement of the bottle 106 in or out of the first chamber 102 is not obstructed by the rod member 120. In one embodiment, the rod member 120 may extend through a fixed sleeve 121 in order to constrain movement of the rod member 120 in directions other than translation along the axis of the rod member 120. This sleeve may comprise a variety of materials, such as poly slide bushing or any material which has a desirably low coefficient of friction.

The rod member 120 is in fluid communication with a pump 122 via a tube 124a. As can be seen, tube 124a is of sufficient length to extend between the pump 122 and the rod member 120 when the rod member 120 is actuated to its maximum distance away from the pump 122. In a further embodiment (not shown), the tube 124a may comprise a coiled portion, so as to provide additional extension of the tube 124a when necessary (e.g., when the rod is engaged with the funnel member), and to retract the tube 124a when necessary, so as to avoid slack tubing interacting with other components. In another embodiment, a filter (not shown) may be provided along the fluid path from the bottle 106 to the fluid outlet. In one embodiment, the filter may be an in-line filter.

In the illustrated embodiment, the pump 122 is further in fluid communication with a cold water reservoir 126 via tube 124b. Cold water reservoir 126 may comprise a container having cooling elements located either within the container or around the container, such that water or other fluid located within the cold water reservoir can be cooled to a desirable temperature. The cold water reservoir may further comprise a sensor which is configured to detect the current temperature of the fluid within the cold water reservoir and adjust the cooling of the water appropriately.

In the illustrated embodiment, a hot water reservoir 128 is also provided, containing heating elements located either within or around the container. In certain embodiments, the hot water reservoir is in fluid communication with cold water reservoir 126 via tubing 124c, as illustrated. In other embodiments, the hot water reservoir 128 may be in fluid communication with pump 122 via tubing, such that fluid can flow to the hot water reservoir without flowing through the cold water reservoir. In other embodiments, not shown, the pump may be in fluid communication with a reservoir having no heating or cooling elements, such that the water within the reservoir remains at room temperature.

In the illustrated embodiment, the pump 122 is in electrical communication with float relay 132, which is further in electrical communication with float switch 134 positioned within cold water reservoir 126. The float switch 134 and float relay 132 can be used to control the pump 122, causing the pump 122 to turn on when the fluid level in the cold water reservoir 126 is below a desired level, attempting to pump water from the bottle 106 to the cold water reservoir 126. When the fluid level in the cold water reservoir 126 has reached a desired level, the pump 122 can be turned off. A similar sensor and control scheme may be employed for the hot water reservoir 128.

The pump 122 may be powered by power source 136, which may also power other components of the fluid dispenser 100 not shown here, such as heating or cooling elements. In one embodiment, power source 136 may comprise one or more batteries in electrical communication with the pump 122. In other embodiments, the power source 136 may comprise a converter or other electronic components configured to permit the fluid dispenser 100 to run on power supplied by an external source, e.g., 110 Volt AC. In a further embodiment, an embodiment of a fluid dispenser may be configured to run on AC power but may also include a battery to provide power to the pump in the event that the external power source is unavailable, such as in the event of a power outage.

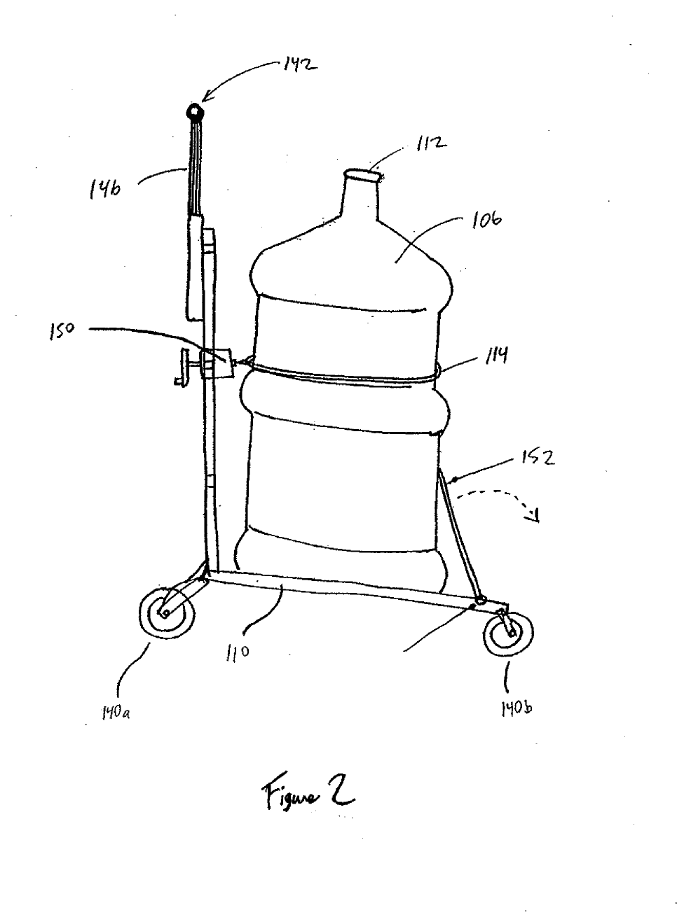

FIG. 2 illustrates a side view of an embodiment of a movable cart 108 for use with a fluid dispenser 100, upon which a bottle 106 is positioned. In the illustrated embodiment, movable cart 108 comprises a platform 110 which is supported on two sets of wheels 140a, 140b. In one embodiment, wheels 140a, located at the rear of platform 110, are turnable with respect to the platform 110, while wheels 140b, located at the front of the platform 110, have a fixed orientation with respect to the platform 110. Such an arrangement facilitates the movement of the cart 108 when being turned. As can be seen, the platform 110 is advantageously oriented at an angle, such that when a bottle 106 is positioned on top of platform 110, the upper surface of fluid contained within the bottle 106 is oriented at an angle to the upper surface of platform 110. This advantageously permits as much fluid as possible to be removed from the bottle 106. In further embodiments, in order to facilitate movement of the loaded cart, the movable cart 108 may comprise motorized wheels.

Extending upward from the rear of the platform 110 is a handle 142 which can be used to maneuver the cart 108. In the illustrated embodiment, the handle 142 comprises a substantially vertical member 144 extending upwards from the platform 110, along with a telescoping upper portion 146, which permits the handle 142 to be raised to a height more comfortable for moving the cart 108, and also to be lowered such that it can be positioned within the first chamber 102 of the fluid dispenser 100 (see FIG. 1). Thus, embodiments wherein the handle 142 comprises a telescoping upper portion 146 advantageously permit the expansion of the handle to a comfortable height during movement of the cart, while permitting the cart to be stored in a smaller chamber within the fluid dispenser. In further embodiments, the handle may comprise multiple substantially vertical members connected with one another via one or more cross-braces.

The front end of the platform 110 comprises a ramp member 152 connected to the platform 110 such that the ramp member can be moved between a first position in which the free end of the ramp member 152 is in contact with the ground, and a second position in which the free end of the ramp member 152 is not in contact with the ground. In one embodiment, the ramp member 152 is coupled to the platform 110 via a hinge. In the illustrated embodiment, it can be seen that the ramp member 152 may be rotatable such that the ramp member 152 can be placed in a second position wherein the free end rests against the bottle 106 supported by the platform 110.

In the illustrated embodiment, the substantially vertical member 144 also supports a gear box 150, which is operably connected to the retention feature 114 extending around the bottle 106 and securing the bottle 106 in place. In one embodiment, the retention FIG. 114 comprises a flexible member, such as a rope. In a further embodiment, the retention FIG. 114 may comprise a noose or noose-like structure securable about the bottle 106. In another embodiment, the retention feature 114 may manually actuated via the gear box 150, such as through the use of a handle operably connected to the gear box. In such an embodiment, the retention feature 114 may be placed about the bottle 106, and manually actuated, e.g., to tighten the retention feature about the bottle, securing it in position on the platform 110. In another embodiment, the retention feature may be actuatable through the use of a motor or similar feature operably connected to the gear box 150. Although the above discussion is generally directed to the use of a flexible member as a retention feature, it will be understood that in other embodiments, rigid components may form at least a part of the retention feature. For instance, the retention feature may comprise one or more rigid components configured to contact and secure the bottle, such as a clamp or claw having rigid members which contact either side of the bottle.

Thus, in a particular embodiment, a method of loading the platform 110 with a bottle 106 includes positioning the cart 108 adjacent to the bottle 106, and positioning the ramp member 152 in a first position, wherein the free end of the ramp member 152 is in contact with the ground near the bottle 106. The retention feature 114 may then be secured about the bottle 106. In certain embodiments, the retention feature is tightened about the bottle. The retention feature 114 is then actuated via the gear box 150 to pull the retention feature 114 and the bottle 106 towards the gear box. This actuation may be either manual or automatic, such as via a motor operably connected to the gear box 150. This actuation pulls the bottle 106 up the ramp member 152 and onto the platform 110. It will be understood that the length of the ramp member 152 and the height of the platform 110 will affect the angle at which the bottle 106 is pulled up the ramp member 152. Thus, the length of the ramp member 152 and the height of the platform 110 can be selected such that a desired angle is obtained. In further embodiments, (not shown), the upper surface of platform 110 may comprise features (not shown) configured to guide the bottle into a particular position on the platform 110, in order to ensure proper placement of the bottle 106 on the cart 108. In one particular embodiment, these features may include a raised U-shaped member which is dimensioned so as to retain a standard water bottle in place, and in a yet further embodiment, the raised member can be removable so as to permit the use of non-standard fluid containers.

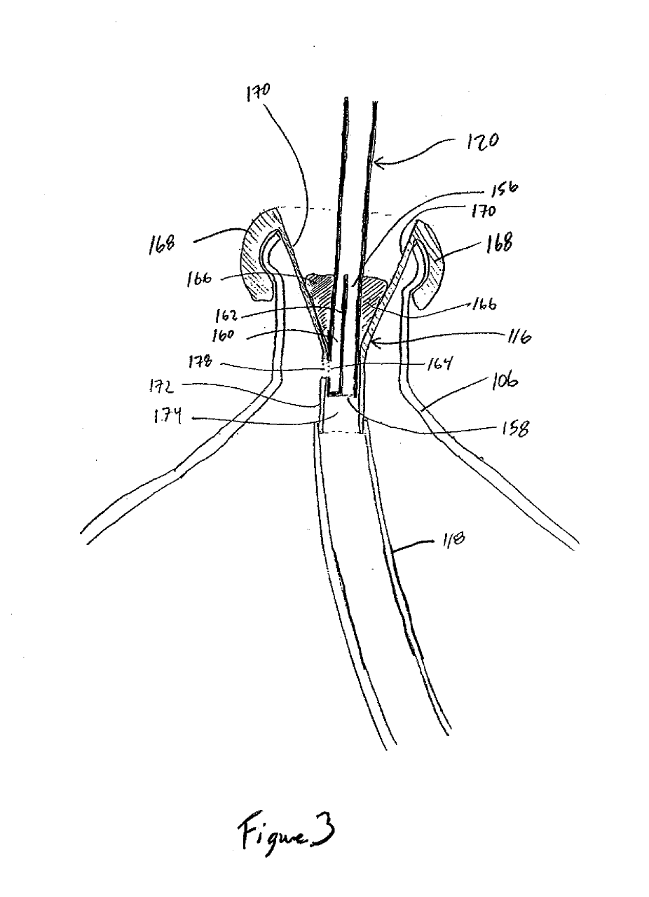

FIG. 3 illustrates in detail one embodiment of a funnel member 116 and a rod member 120 configured to engage the funnel member 116 in order to provide fluid communication between the interior of the bottle 106 and the pump 122. In the illustrated embodiment, the rod member 120 comprises a first lumen 156 extending the length of the rod member 120 from a proximal upper end (not shown in FIG. 3) to a first aperture 158 located at the distal end of the rod member 120. A second lumen 160 extends from the upper end of a barrier 162 dividing the interior of rod member 120 to a second aperture 164 located distal the upper end of the barrier 162. In the illustrated embodiment, the second aperture 164 extends through the sidewall of the rod member 120 near the distal end of the rod member 120. In a particular embodiment, the rod member 120 may comprise a stainless steel pipe. A sealing member such as rubber grommet 166 may extend about a portion of the rod member 120 in order to provide an airtight seal. In other embodiments, the sealing member may comprise a variety of other materials or components, but preferably comprise a resilient material so as to provide a tight seal.

Still with respect to FIG. 3, it can be seen that in the illustrated embodiment, the funnel member 116 is held in place at the top of the bottle by cap 168 which extends over the edges of the upper portion of bottle 106, and is configured to secure the funnel member 116 in place. It can also be seen that funnel member 116 comprises a substantially conical portion 170 whose inner surface is configured to accept and retain a sealing member, such as the rubber grommet 166. Funnel member 116 further comprises a substantially cylindrical portion 172 extending from the narrow end of conical portion 170, which comprises a lumen 174 configured to receive the rod member 120. Advantageously, at least conical portion 170 comprises a substantially resilient material such that the conical portion 170 is able to flex and bend in order to accept rod member 120 even when the rod member is slightly misaligned with respect to cylindrical portion 172. Tube member 118 extends downward from cylindrical portion 172, and is configured to reach the lowest portion of the bottle 106, as discussed with respect to FIG. 1.

It can also be seen that aperture 178 extending through a sidewall of cylindrical portion 172 is configured to align with aperture 164 extending through the sidewall of rod member 120, placing the second lumen 160 in fluid communication with the interior of bottle 106 when the funnel member 116 is placed in the opening of the bottle 106 and the rod member 120 engages the funnel member 116. Thus, the second lumen 160 provides air return to the interior of the bottle 106 when water is pumped upward via tube member 118 and first lumen 156. Proper alignment of the apertures 164 and 178 can be provided through the placement of rubber grommet 166, which constrains translation of the rod member 120 with respect to the funnel member 116, and the fabrication of an aperture 178 of sufficient dimension to ensure that there is some room for error in the alignment of the funnel member.

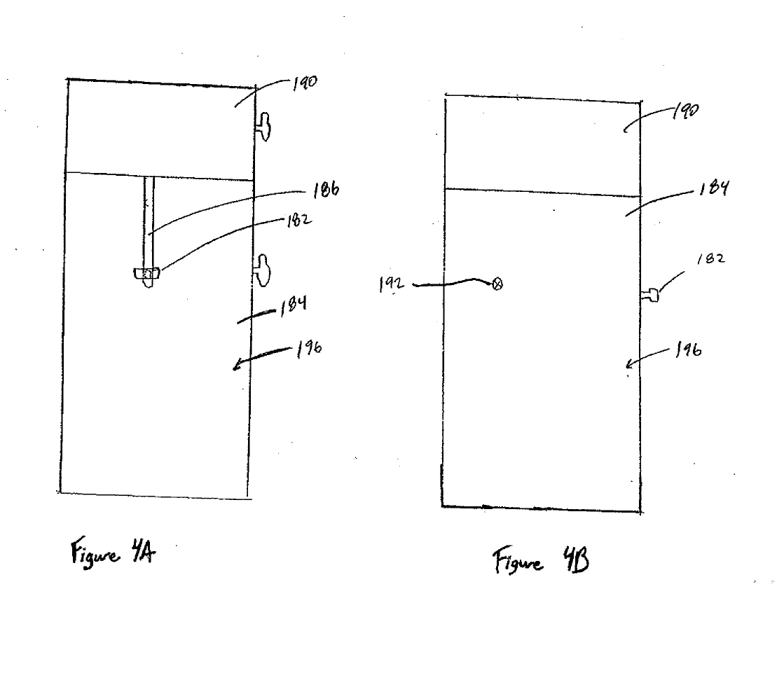

FIGS. 4A and 4B are exterior views of a fluid dispenser according to one embodiment of the invention. In FIG. 4A, it can be seen that handle 182 extends from the side of fluid dispenser housing 184, and is actuatable along slot 186 extending vertically up the side of housing 184. Handle 182 is operably connected to rod member 120, and actuation of handle 182 between an upward position and a downward position moves the rod member 120 upward and downward, and causes the rod member to disengage or engage the funnel member 116.

It can also be seen in FIG. 4A that a dispensing component 190 is positioned on top of the fluid dispenser 100. In one embodiment, the dispensing component may include a drink mixer or dispenser, such as a coffee maker or a dispenser for providing drinks made from mixes, such as lemonade. In the illustrated embodiment, the dispensing component is in fluid communication with the hot or cold water reservoirs 128 and 126, or directly with the pump 122, in order to receive fluid from the fluid dispenser 100 and utilize that fluid in dispensing a mixed or otherwise prepared drink. In a particular embodiment, the fluid connection between the fluid dispenser 100 and the dispensing component 190 may be concealed between the two, both for aesthetic purposes and to provide protection for the connection from accidental dislodgement or other damage. In other embodiments, it will be understood that the dispensing component 190 need not be positioned on top of the fluid dispenser 100, as illustrated, but may be positioned to one side of the fluid dispenser 100. In further embodiments, the components of the dispensing component 190 may be integrated into the fluid dispenser 100 itself, such that the mixing or other preparation of a drink may be performed within the fluid dispenser 100.

With respect to FIG. 4B, in an alternate embodiment, a fluid connection between the dispenser and an external device may be provided via a fluid port 192 which in the illustrated embodiment is positioned on the rear of the device. The fluid port 192 may also be used to provide connections between the fluid dispenser 100 and external devices (not shown) such as a refrigerator, in order to provide a source of water to such external devices. For example, in one embodiment, the fluid port 192 may be placed in fluid communication with a refrigerator via a length of tubing and may be used to provide a source of water to an ice dispenser within the refrigerator. Within the housing 184, the fluid port 192 may be directly in fluid communication with the pump 122, or may be in fluid communication with one of the hot or cold reservoirs 126, 128.

In a particular embodiment, a method of placing the pump 122 in fluid communication with a bottle 106 containing fluid is described. Funnel member 116, including tube member 118, is placed within the opening 112 in the top of bottle 106. Tube member 118 is preferably positioned such that the lowest portion of the bottle is reached by the distal end tube member 118. Bottle 106 is positioned, such as by using movable cart 108, within first chamber 102 of fluid dispenser such that the opening 112 in the top of the bottle is located along the axis of translation of rod member 120. Rod member 120 is actuated to a position, such as by actuating handle 182, in which the distal portion of rod member 120 engages the cylindrical portion 172 of the funnel member 116. The funnel member 116 is preferably positioned with respect to the rod member 120 such that aperture 178 extending through the sidewall of cylindrical portion 172 of funnel member 116 is aligned with aperture 164 extending through the sidewall of rod member 120.

The pump 122 may then be actuated, pulling fluid from the bottle 106 up the tube member 118 and to the pump 122 via the first lumen 156 of rod member 120, and further via the tubing 124a connecting the rod member 120 and the pump 122. From there, the fluid may be pushed directly to an outlet, such as a dispenser or faucet, to an external device, such as via fluid port 192, or to a reservoir such as cold water reservoir 126 or hot water reservoir 128.

As can be seen in FIGS. 4A and 4B, due to the positioning of the bottle underneath the other components of the fluid dispenser, and the ease by which a movable cart permits loading of bottles into the fluid dispenser, the fluid dispenser may be contained within a compact and aesthetically pleasing housing 196. The bottle loaded in the water need not be exposed as in many current bottled water dispensers, and the clearance required to load the bottles is significantly reduced as compared to bottled water dispensers wherein significant clearance is required to manually position the water bottles, in order to avoid injury.

In further embodiments, the housing 196 may comprise removable and replaceable panels, such that the appearance of the fluid dispenser may be modified. In a particular embodiment, the housing 196 may comprise a frame to which ornamental panels can be affixed. In another embodiment, the housing 196 may form a component of a larger item. For example, the fluid dispenser may be built into a cabinet, sofa, bookshelf, desk, bench or any similar article.

Various modifications may be made to the embodiments. It is also to be recognized that, depending on the embodiment, the acts or events of any methods described herein can be performed in other sequences, may be added, merged, or left out altogether (e.g., not all acts or events are necessary for the practice of the methods), unless the text specifically and clearly states otherwise. For example, one embodiment of a fluid dispenser may comprise a retention feature coupled to the interior of the fluid dispenser, rather than to a movable cart, such that a bottle may be positioned adjacent the fluid dispenser and pulled into the fluid dispenser via a retention feature secured about the bottle. In a further embodiment, the fluid dispenser may comprise a sloped platform upon which the bottle can be positioned.

While the above detailed description has shown, described, and pointed out novel features of the invention as applied to various embodiments, it will be understood that various omissions, substitutions, and changes in the form and details of the device of process illustrated may be made by those skilled in the art without departing from the spirit of the invention. As will be recognized, the present invention may be embodied within a form that does not provide all of the features and benefits set forth herein, as some features may be used or practiced separately from others.

What is claimed is:

1. An apparatus for dispensing fluid from a container, said apparatus comprising:
a movable platform configured to support a container, said movable platform comprising:
a first surface, wherein said first surface is configured to support the container such that the upper surface of fluid within the container is at an angle to said first surface;
a ramp member connected to an edge of the first surface via a hinge, said ramp member being rotatable about the hinge from a first position in which an edge of the ramp member is in contact with the ground, to a second position in which an edge of the ramp member is supported by either the first platform or a container located on said platform; and
a substantially vertical member extending upward from said platform;
a flexible member configured to extend around at least a portion of the container; and
a gear box supported by said substantially vertical member and operably connected to the flexible member, wherein said gear box is configured to pull said flexible member towards said gear box.

2. The apparatus of claim 1, additionally comprising:
a funnel member configured to be placed in an aperture located in an upper surface of a container; and
a rod member translatable along the axis of the rod member between a first position in which the rod member is separated from the funnel member, and a second position in which a distal end of the rod member engages the funnel member.

3. The apparatus of claim 2, wherein the rod member comprises a first lumen extending the length of the rod member, said lumen comprising a first end located at the distal end of the rod member, and said second end located at the proximal end of the rod member, and a second lumen comprising a first end located at an aperture in the side of the rod member near the distal end of the rode member, and a second end in fluid communication with a portion of said first lumen.

4. The apparatus of claim 2, wherein the funnel member comprises:
a hollow conical portion; and
a substantially cylindrical portion extending from the narrower end of the conical portion, said substantially cylindrical portion comprising luminal area configured to receive the rod member.

5. The apparatus of claim 1, wherein the flexible member comprises a loop of flexible material.

6. The apparatus of claim 1, wherein the movable platform comprises wheels.

7. The apparatus of claim 1, wherein the gear box is manually actuatable.

8. The apparatus of claim 1, wherein the gear box is actuatable via an electric motor.

9. The apparatus of claim 1, additionally comprising a dispensing component, wherein said dispensing component can be placed in fluid communication with said pump.

10. An apparatus for dispensing fluid from a container, said apparatus comprising:
a platform configured to support a container, such that an upper surface of fluid within the container is at an angle to the platform;
a rod member, comprising:
a first lumen extending the length of the rod member, said lumen comprising a first end located at the distal end of the rod member, and said second end located at the proximal end of the rod member; and
a second lumen comprising a first end located at an aperture in the side of the rod member near the distal end of the rode member, and a second end in fluid communication with a portion of said first lumen;
a funnel member configured to be placed in an aperture located in an upper surface of a container, wherein said funnel member is configured to receive the distal end of said rod member, said funnel member comprising:
a hollow conical portion having an outer diameter at the widest point of the conical portion which is larger than the diameter of the aperture;
a substantially cylindrical portion extending from the narrower end of the conical portion, said substantially cylindrical portion comprising a luminal area configured to receive the rod member; and
a flexible tube in fluid communication with the luminal area of the substantially cylindrical portion, wherein said flexible tube is configured to reach substantially the lowest portion of the container.

11. The apparatus of claim 10, wherein the substantially cylindrical portion of the funnel member comprises an aperture extending through the side of the substantially cylindrical portion and in fluid communication with the luminal area of the substantially cylindrical portion, and wherein the first end of the second lumen can be placed in fluid communication with said aperture when the rod member engages the funnel member.

12. The apparatus of claim 10, the funnel member additionally comprising a flexible tube in fluid communication with the luminal area of the substantially cylindrical portion.

13. The apparatus of claim 10, the funnel member additionally comprising an aperture extending through the side of the substantially cylindrical portion and in fluid communication with the luminal area of the substantially cylindrical portion.

14. The apparatus of claim 10, the rod member additionally comprising a retention feature extending about the rod member, the retention feature configured to form a seal between the rod member and the funnel member.

15. The apparatus of claim 14, wherein the retention feature comprises a rubber grommet configured to form a seal with an interior surface of the hollow conical portion.

16. The apparatus of claim 10, additionally comprising a fixed sleeve through which the rod member extends, wherein said fixed sleeve constrains movement of said rod member other than translation along the axis of the rod member.

17. A method of preparing an apparatus to dispense fluid from a container, said method comprising:
inserting a funnel member into an aperture in an upper surface of the container, the funnel member comprising a hollow conical portion, a substantially cylindrical portion extending from the narrow end of the conical portion, and a flexible tube extending from the substantially cylindrical portion toward the base of the container;
securing a flexible member around at least a portion of the container;
actuating a gear box to pull the flexible member toward the gear box, thereby pulling the container onto a movable platform to which the gear box and the flexible member are operably connected, the movable platform including a ramp member extending downward at an angle from the edge of a first surface, the first surface configured to support the container such that an upper surface of fluid within the container is oriented at an angle to the first surface; and
translating a rod member along the axis of the rod member to engage the distal end of the rod member with the funnel member, such that the proximal end of the rod member is in fluid communication with the distal end of the flexible tube.

18. The method of claim 17, wherein:
the substantially cylindrical portion of the funnel member comprises an aperture extending through the side of the cylindrical portion;
the rod member comprises a first lumen extending from the proximal end of the rod member to the distal end of the rod member, and a second lumen extending from a first end located at an aperture in the side of the rod member near the distal end of the rode member and a second end in fluid communication with a portion of said first lumen; and
engaging the distal end of the rod member with the funnel member comprises aligning the aperture in the cylindrical portion of the funnel member with the aperture in the side of the rod member.

19. An apparatus for dispensing fluid from a container, the apparatus comprising:
means for positioning said container, wherein said positioning means are configured to support the container such that an upper surface of the fluid is oriented at an angle to the base of the container;
means for securing the container to the positioning means;
means for loading said container onto said positioning means, wherein said loading means are configured to translate the securing means with respect to the positioning means, thereby pulling the container onto said positioning means; and
means for dispensing fluid from the container, wherein said dispensing means simultaneously permit the influx of air into the container as fluid is dispensed.
